(19) United States
(12) Patent Application Publication
(10) Pub. No.: US 2014/0238977 A1
(43) Pub. Date: Aug. 28, 2014

(54) COMPOSITE ARTICLE WITH INDUCTION LAYER AND METHODS OF FORMING AND USE THEREOF

(71) Applicant: TherCom Holdings, LLC, Bloomfield Hills, MI (US)

(72) Inventor: Joel A. Dyksterhouse, Cross Village, MI (US)

(73) Assignee: TherCom Holdings, LLC, Bloomfield Hills, MI (US)

(21) Appl. No.: 14/186,330

(22) Filed: Feb. 21, 2014

Related U.S. Application Data
(60) Provisional application No. 61/768,120, filed on Feb. 22, 2013.

(51) Int. Cl. B29C 65/36; B29C 47/00

(52) U.S. Cl. CPC B29C 65/3604; B29C 47/0064
USPC 219/633; 219/635; 156/60; 156/322; 156/244.11

(57) ABSTRACT

A multi-layer composite article for fusing to a substrate comprises a polymeric composite layer having a first polymeric matrix and an induction layer having a second polymeric matrix that includes an induction current-susceptible material. An induction current can be applied to the multi-layer composite article to generate heat within the induction layer to fuse the polymeric composite layer and/or the induction layer to an adjacent substrate.

### CROSS-REFERENCE TO RELATED APPLICATIONS

This application claims the benefit of U.S. Provisional Patent Application No. 61/768,120, filed Feb. 22, 2013, which is incorporated herein by reference in its entirety.

### BACKGROUND

Thermoplastic tapes can be used to bond to a substrate by heating the thermoplastic tape to melt the thermoplastic such that the thermoplastic fuses with the substrate. For example, thermoplastic tapes can be used to bond a pipe liner and a pipe jacket to form pipes that can be used to transport materials such as oil, gas, water and sewage. Typically, the heat required to melt the thermoplastic tape is supplied through convection, infrared or microwave heating.

### BRIEF SUMMARY

According to an embodiment of the invention, a composite article for fusing to a substrate comprises a polymeric composite layer having a first polymeric matrix comprising at least one polymeric resin and an induction layer joined to the polymeric composite layer, wherein the induction layer has an induction-current susceptible material that generates heat when exposed to a magnetic field, wherein the induction layer is separate from the polymeric composite layer.

According to one embodiment, the first polymeric matrix includes a reinforcement material. In another embodiment, the induction-current susceptible material is a metal particulate.

In yet another embodiment, the induction layer includes a carrier matrix with at least one polymeric resin. The first polymeric matrix and the carrier matrix can comprise the same polymeric resin. The polymeric resin of the first polymeric matrix can be a polyethylene-based resin.

According to another embodiment of the invention, a method of forming a composite article for fusing to a substrate comprises providing a polymeric composite layer having a first polymeric matrix comprising at least one polymeric resin, providing an induction layer having an induction-current susceptible material that generates heat when exposed to a magnetic field, and joining the induction layer to the polymeric composite layer, wherein the induction layer is separate from the polymeric composite layer.

In another embodiment, the method further comprises forming the polymeric composite layer by combining a reinforcement material with a polymer resin. The reinforcement material can include glass fibers and the forming can include heating the glass fibers. The polymer resin can be applied to the reinforcement material by way of an extruder. The reinforcement material can include heated glass fibers and the forming can include moving the heated glass fibers and the applied polymer resin through heated pins to form a fully wet-out polymeric fiber composite.

In yet another embodiment, the joining step comprises applying at least one of heat, pressure or a combination of heat and pressure to the polymeric composite layer and the induction layer. In another embodiment, the joining step includes heating the polymeric composite layer and applying the heated polymeric composite layer to the induction layer to form a bond between the polymeric composite layer and the induction layer. In a still further embodiment, the joining step is combined with providing the induction layer step by heating and extruding a polymeric resin and the induction-current susceptible material onto the polymeric composite layer.

According to another embodiment, a method of joining a first polymeric material to a second polymeric material comprises providing a polymeric composite-induction tape formed of a polymeric composite layer having a first polymeric matrix with at least one polymeric resin, and a separate induction layer joined to the polymeric composite layer, wherein the induction layer has an induction-current susceptible material, placing at least one layer of the polymeric composite-induction tape between the first polymeric material and the second polymeric material with at least one of the polymeric composite layer or the induction layer in contact with the first polymeric material and the other of the polymeric composite layer or the induction layer in contact with the second polymeric material, and performing an induction cycle to melt at least one of the polymeric composite layer or induction layer to fuse the at least one of the polymeric composite layer or induction layer to the adjacent first polymeric material and the second polymeric material.

In another embodiment, the first polymeric material is a pipe jacket and the second polymeric material is a pipe liner. The placing step can include wrapping the at least one layer of polymeric composite-induction tape around the pipe liner. Further, more than one layer can be wrapped around the pipe liner and the performing step can be repeated for each layer.

In another embodiment, the placing at least one layer of polymeric composite-induction tape and the performing an induction cycle are repeated at least once to join the first polymeric material to the second polymeric material by at least two layers of polymeric composite-induction tape.

### BRIEF DESCRIPTION OF THE DRAWINGS

In the drawings:

FIG. 1 is a perspective view of a multi-layer composite article according to an embodiment of the invention.

FIG. 2 is a flow chart illustrating a method of forming a multi-layer composite article according to an embodiment of the invention.

FIGS. 3A-C are schematic illustrations of processes for forming a polymeric composite-induction tape with the multi-layer composite article of FIG. 1 according to an embodiment of the invention.

FIG. 4 is a perspective view of a segment of a pipe formed using a polymeric composite-induction tape according to an embodiment of the invention.

FIG. 5 is a flow chart illustrating a method of forming a pipe using a polymeric composite-induction tape according to an embodiment of the invention.

FIG. 6 is a cross-sectional view of the pipe segment illustrated in FIG. 4 taken along the line VI-VI according to an embodiment of the invention.

FIG. 7A is a cross-sectional view of a portion of a polymeric composite-induction tape according to an embodiment of the invention.

FIG. 7B is a cross-sectional view of a portion of an alternative tape.

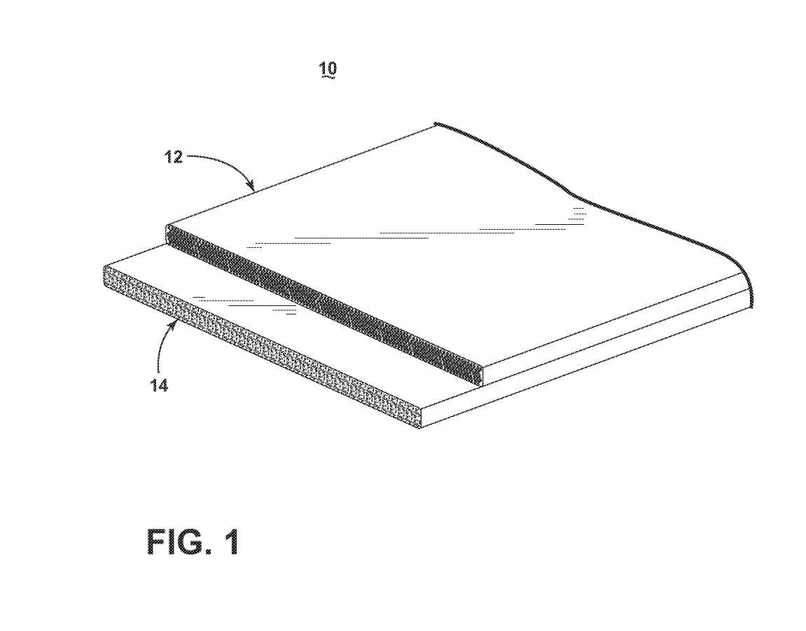

### DETAILED DESCRIPTION

The invention relates to a multi-layer composite article 10 comprising a polymeric composite layer 12 and an induction layer 14. According to an embodiment of the invention, the multi-layer composite article 10 can be used to provide a tape for use in wrapping pipes, such as pipes used in the gas and oil industry or used in the transport of water or sewage, for example. In one example, the multi-layer article 10 can be used for bonding a pipe jacket and pipe liner forming a pipe, such as a high pressure pipe used in the oil and gas industry.

The polymeric composite layer 12 can comprise a polymeric matrix which can include one or more thermoplastic resins. An example of a suitable thermoplastic resin includes polyethylene (PE), such as high density polyethylene (HDPE). The thermoplastic resin can be selected based on its compatibility with the substrate to which the polymeric resin layer 12 will be applied. The polymeric matrix can include reinforcement materials, such as glass, carbon, aramid or other natural or synthetic fibers known in the art. The polymeric composite layer 12 can be selected based on the desired properties of the layer and the intended use of the multi-layer article 10. For example, the polymeric composite layer 12 can be selected to be tough and have a high elongation to break length or suitable for use in cold weather or other weather extremes. Additional additives, such as colorants, preservatives, and fillers, for example, can be used in the polymeric composite layer 12, as is known in the art.

The induction layer 14 comprises a carrier matrix and an induction current-susceptible material. The carrier matrix can be made from a polymeric resin or combination of resins that is the same or different than the polymeric resin or combination of resins used in the polymeric composite layer 12. The carrier matrix can be selected based on compatibility with the polymeric composite layer 12 and is preferably capable of bonding with the polymeric composite layer 12. The induction current-susceptible material can be a particulate material, such as iron, iron alloy or other metal particulates, for example, which generate heat when exposed to a varying magnetic field. The carrier matrix and induction current-susceptible material can be selected based on the desired properties of the induction layer 14. For example, the carrier matrix can be selected to be tough and have a high elongation to break length or suitable for use in cold weather or other weather extremes.

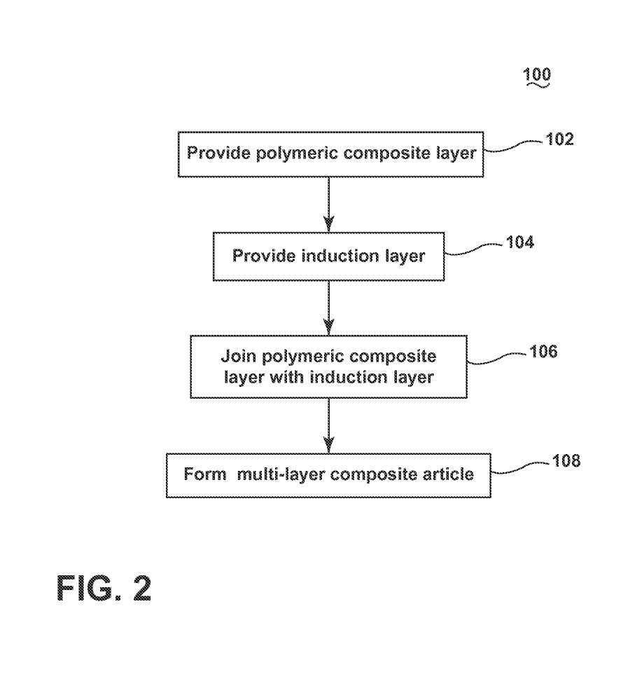

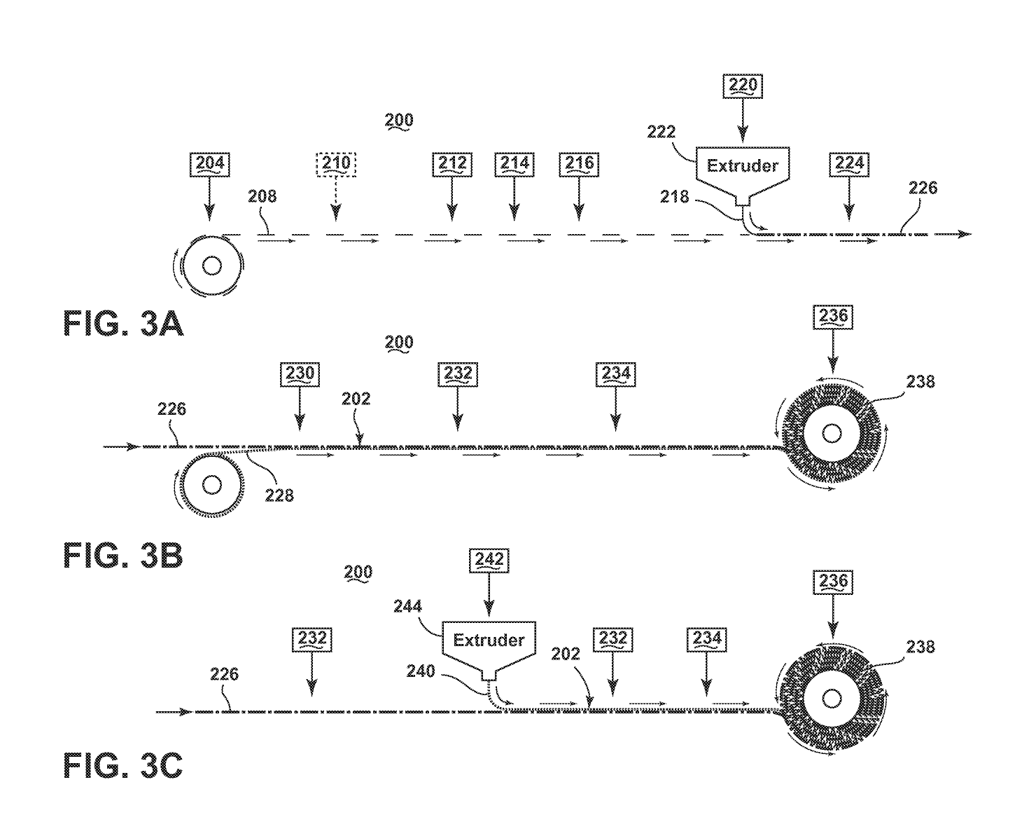

FIGS. 2 and 3A-3C illustrate a flow chart of a method 100 for forming a multi-layer composite article 10 and a process 200 for forming a polymeric composite-induction tape 202 comprising the multi-layer article 10, respectively, in accordance with the embodiments of the invention. The sequence of steps depicted for any of the methods and processes described herein are for illustrative purposes only, and are not meant to limit the methods or processes in any way as it is understood that the steps may proceed in a different logical order, steps may be omitted, or additional or intervening steps may be included without detracting from the invention.

The method 100 includes providing a polymeric composite layer at 102 and an induction layer at 104. At 106 the polymeric composite layer and induction layer can be joined to form a multi-layer composite article at 108. The polymeric composite layer and induction layer provided at 102 and 104 can be joined at 106 by applying heat and/or pressure, which can include performing an induction cycle. It is also within the scope of the invention for any of the steps 102 through 106 to be repeated sequentially or simultaneously to provide a multi-layer article having more than two layers.

Referring now to FIGS. 3A-3B, a process 200 for forming a polymeric composite-induction tape 202 comprising the multi-layer article 10 is illustrated in accordance with the embodiments of the invention. As illustrated in FIG. 3A, the process 200 can begin at 204 in which a spool having a predetermined reinforcement material 208, such as glass fibers, for example, is provided to the system. At 210 the glass fiber 208 can optionally be fed through a heated oven to heat the glass fibers 208 prior to drawing the glass fibers 208 over breaker bars at 212 to disrupt the sizing of the fibers 208. The breaker bars can be cylindrical and have an adjustable arrangement. The glass fibers 208 can then be fed through a comb at 214 which determines the initial width of the tape 202 by setting the distribution of the glass fibers 208. At 216 the glass fiber 208 can be drawn over pre-heating bars to heat the glass fibers 208 prior to application of a polymer resin melt matrix 218 at 220.

The polymer resin melt matrix 218 can comprise a polymer resin matrix, which may optionally include one or more additives, that has been heated in an extruder 222, for example, to melt the polymer resin matrix 218 for application to the glass fibers 208. The polymer resin melt matrix 218 and glass fibers 208 can be fed through moving heated pins at 224 to provide a polymeric composite layer 12 in the form of a polymeric composite tape layer 226. By moving the polymer resin melt matrix 218 and glass fibers 208 through the heated pins, the melted polymer resin surrounds and encapsulates the fibers to form what is sometimes referred to in the art as a fully wet-out polymeric fiber composite. The heated pins can have an adjustable arrangement and shape depending on the desired characteristics of the polymeric composite tape layer 226.

While the process 200 is discussed in the context of preparing a polymeric composite tape layer 226 having a polymer resin melt matrix 218 that includes glass fibers 208, it will be understood that the process 200 can be used in a similar manner with a variety of different fillers or combinations of fillers or that fillers can be excluded from the polymer resin melt matrix 218 without deviating from the scope of the invention. It is also within the scope of the invention for additional additives to be used in preparing the polymeric composite tape layer 226, such as colorants or preservatives, for example.

The polymeric composite tape layer 226 can be stored for later use or immediately used in forming the polymeric composite-induction tape 202. Referring now to FIG. 3B, according to one embodiment of the invention, the polymeric composite tape layer 226 can be applied to the induction layer 14, which is provided as a pre-formed induction film 228. The pre-formed induction film 228 can comprise a polymeric resin that is the same as the polymeric resin used to form the polymeric composite tape layer 226 or a different, compatible polymeric resin capable of bonding with the polymeric composite tape layer 226. The polymeric composite tape layer 226 can be heated at 230, such as by feeding through heated rollers, before, during and/or after application of the pre-formed induction film 228 to bond the film 228 to the polymeric composite tape layer 226 to form the polymeric composite-induction tape 202. The hot polymeric composite-induction tape 202 can then be cooled by passing the tape 202 through rollers and/or water jets at 232 and then drawn through a pull-roller system at 234 which draws the tape 202 under high tension through the entire system. At 236 the polymeric composite-induction tape 202 can be taken-up on a spool 238 for storage and subsequent use.

Referring now to FIG. 3C, an alternative method for forming the polymeric composite-induction tape 202 is illustrated. Rather than applying the induction layer 14 as a pre-formed induction film, as illustrated in FIG. 3B, the induction layer 14 can be extruded as a thin film onto the polymeric composite tape layer 226. The polymeric composite tape layer 226 can be cooled at 232, such as by passing the polymeric composite tape layer 226 through chill rollers and/or water jets. The induction layer 14 can be applied as an induction-polymer resin melt 240 having a polymeric resin carrier matrix and an induction current-susceptible material. The induction-polymer resin 240 can comprise a polymeric resin that is the same as the polymeric resin used to form the polymeric composite tape layer 226 or a different, compatible polymeric resin capable of bonding with the polymeric composite tape layer 226. The induction-polymer resin 240 can be heated, such as in an extruder 244, at 242, and the molten induction-polymer resin 240 can be extruded through an appropriate dye onto the polymeric composite tape layer 226 to form the polymeric composite-induction tape 202. The polymeric composite-induction tape 202 can then be cooled at 232 and drawn through a pull-roller system at 234 which draws the tape 202 under high tension through the entire system. At 236 the polymeric composite-induction tape 202 can be taken-up on a spool 238 for storage and subsequent use.

It will be understood that for both processes illustrated in FIGS. 3B and 3C, it is within the scope of the invention for the pre-formed induction film 228 and the induction-polymer resin melt 240, respectively, to be applied to either the bottom of the polymeric composite tape layer 226, the top or both.

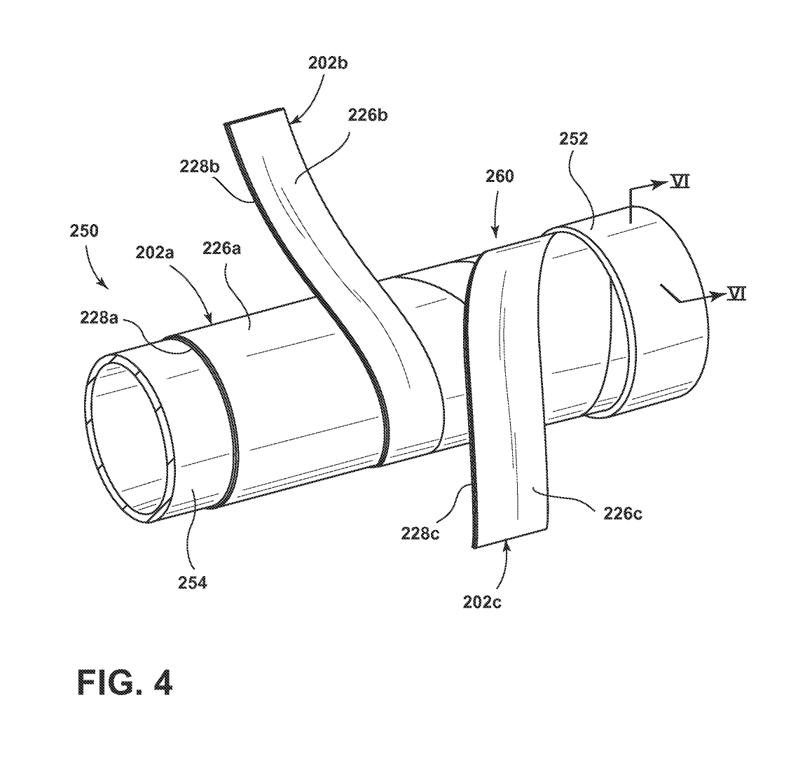

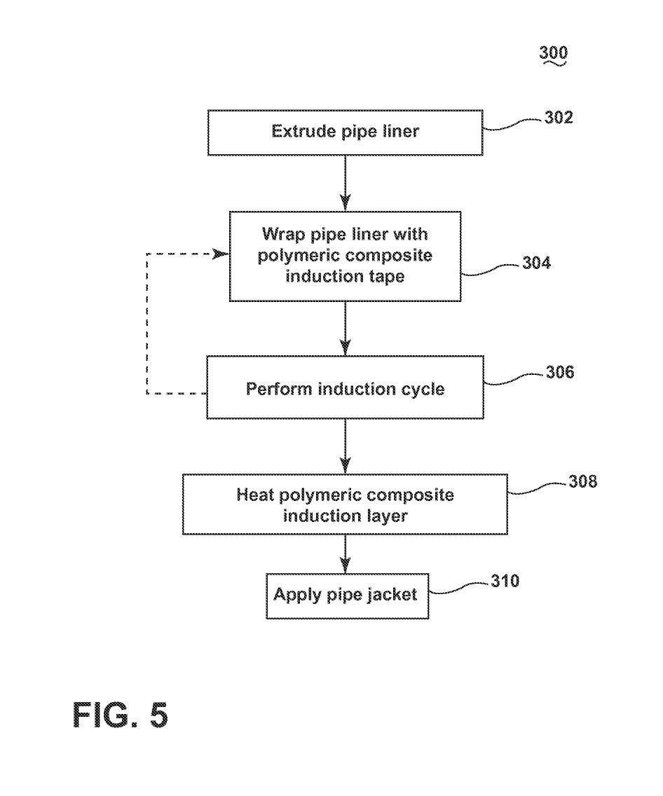

Referring now to FIGS. 4 and 5, as illustrated in FIG. 4, multiple layers of a polymeric composite-induction tape 202a-202c are illustrated as being used to join two substrates made of a polymeric material, such as a pipe jacket 252 with a pipe liner 254, for example. While the embodiments of the invention are disclosed in the context of joining a pipe jacket 252 and pipe liner 254 using one or more layers of a polymeric composite-induction tape 202, it will be understood that it is within the scope of the invention to use the polymeric composite-induction tape 202 to join any substrates having a surface made from a material capable of fusing with the polymeric composite-induction tape 202. As illustrated, the multiple layers of the polymeric composite-induction tape 202a-202c can be applied to a segment of a pipe 250 to bond the pipe jacket 252 with the pipe liner 254 to form the pipe segment 250. FIG. 4 illustrates the pipe 250 with a portion of the pipe jacket 252 removed to reveal the polymeric composite-induction tape 202a-202c and pipe liner 254 for illustrative purposes.

The pipe jacket 252 and pipe liner 254 can be made from any suitable polymeric material based on the intended use of the pipe 250. In one exemplary embodiment, the pipe jacket 252 and pipe liner 254 can be made from a PE-based resin, an example of which includes an HDPE resin, such as a bimodal 4710 HDPE resin, for example, based on its approval in the oil and gas industry for transportation of hydrocarbon gas and liquid. In this exemplary embodiment, the polymeric composite tape layer 226a-226c comprises from 55-75% by weight fiber glass reinforcements in a high melt flow HDPE resin matrix. The induction film 228a-228c comprises an HDPE resin carrier matrix with fine iron powder, such as 375 mesh, as the induction current-susceptible material. The iron powder can form about 30% of the volume of the induction film 228a-228c, although the amount may vary depending on the materials used in the polymeric composite-induction tape 202a-202c and pipe 250 and the intended use. The materials used to form the pipe jacket 252 and polymeric composite-induction tape 202a-202c can be selected based on their compatibility with each other and with the pipe liner 254, based on the desired characteristics and requirements in the intended field of use.

FIG. 5 illustrates a method 300 for joining two substrates with the polymeric-composite induction tape 202. In an exemplary embodiment, the method 300 can be used to apply the polymeric composite-induction tape 202 to a pipe segment, such as the pipe segment 250 illustrated in FIG. 4. The method starts at 302 with providing a first substrate, such as the pipe liner 254, for example. The pipe liner 254 can be provided at 302 by extruding the pipe liner 254, comprised of an HDPE resin, for example, and then cooling the pipe liner 254. At 304, the polymeric composite-induction tape 202 can be applied to the first substrate, such as by wrapping the cooled piper liner 254 in one or more layers of the polymeric composite-induction tape 202. The number of layers, the width and the thickness of the polymeric composite-induction tape 202 can be selected to provide the desired characteristics of the final pipe, such as to provide a desired burst pressure. In an exemplary embodiment, each layer of polymeric composite-induction tape 202 contains a 5 millimeter layer of induction film 228 containing about 30% by volume of iron powder.

With reference to FIGS. 4 and 5, at 306 an induction cycle can be performed to melt the one or more layers of induction film 228a-228c, fusing, also referred to as fusion bonding, the induction film 228a-228c to an adjacent pipe liner 254 or polymeric composite tape layer 226a-226c to form a polymeric composite-induction layer 260 bonded to the pipe liner 254. In an exemplary embodiment, each step 304 and 306 can be performed sequentially for each layer of polymeric composite-induction tape 202a-202c applied to the pipe segment 250. For example, at step 304 a first layer of polymeric composite-induction tape 202a can be applied to the pipe liner 254 and an induction cycle performed at 306 to heat the induction film 228a to melt the induction film 228a such that the induction film 228a can bond to the pipe liner 254. Step 304 can be repeated with the application of a second layer of polymeric composite-induction tape 202b. The second layer of polymeric-composite induction tape 202b can be heated during an induction cycle 306 to melt the induction film 228b such that the induction film 228b bonds to the adjacent polymeric composite tape layer 226a. Step 304 can then be repeated a third time with the application of a third layer of polymeric composite-induction tape 202c followed by a subsequent induction cycle at 306 to heat the third layer of polymeric-composite induction tape 202c such that the induction film 228c bonds to the adjacent polymeric composite tape layer 226b. Steps 304 and 306 can be repeated any number of times depending on the number of layers of polymeric-composite induction tape 202 to form the polymeric composite-induction layer 260. It is also within the scope of the invention for more than one layer of polymeric-composite induction tape 202 to be applied at 304 prior to performing one or more induction cycles at 306.

Referring again to FIG. 5, at 308 the polymeric composite-induction layer 260 can be heated in an oven to bring the surface temperature of the polymeric composite-induction layer 260 close to the melt temperature of the matrix resin forming the polymeric composite tape layer 226. At 310 the pipe jacket 252 is applied to the outside of the pipe 250, through an overcoat die, for example, such that the pipe jacket 252 bonds to the matrix resin of the adjacent polymeric composite-induction tape layer 202c. The wrapped pipe 250 can then be cooled and optionally wound on spools for shipping or storage.

As illustrated in FIG. 4, the polymeric composite-induction tape 202 can be provided as a sheet, such as tape 202a, having any desired dimensions for application to a pipe or any other curved or un-curved surface. Alternatively, the polymeric composite-induction tape 202 can be provided as strips and coiled around a pipe, such as illustrated by tape 202b and 202c.

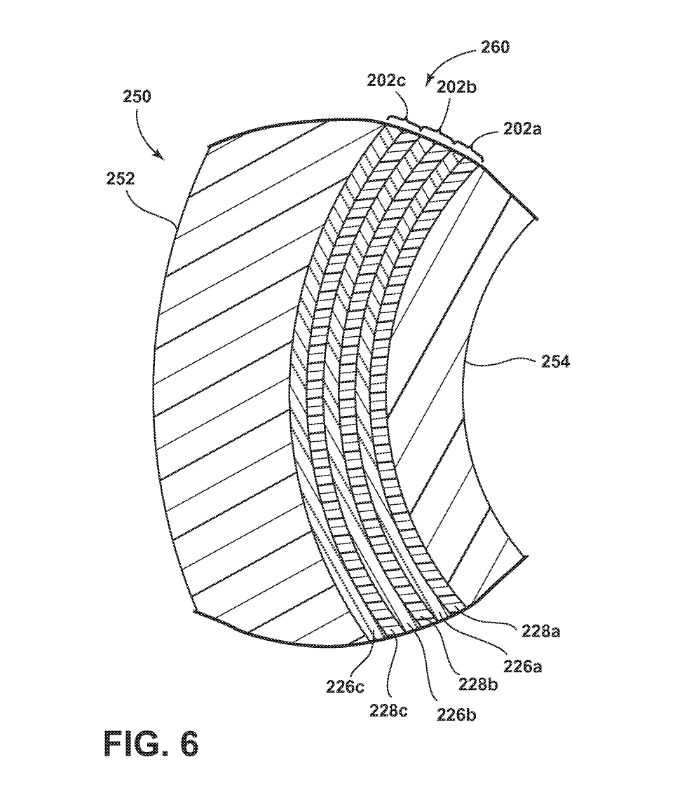

Referring now to FIG. 6, each induction cycle 306 of the method 300 illustrated in FIG. 4, generates heat only within the induction film layers 228a-c, as these are the only layers that include an induction current-susceptible material, which in this example are iron particles. The heat generated in the induction film layers 228a-c is transferred to the adjacent polymeric composite tape layers 226a-c, bonding each polymeric-composite induction tape layer 202a-202c to an adjacent tape layer 202a-202c or the pipe liner 254. After completion of the induction cycles, the polymeric composite-induction layer 260 comprises multiple polymeric composite-induction tape layers 202a-c that are bonded together to form a void free, multi-axial polymeric composite-induction layer 260.

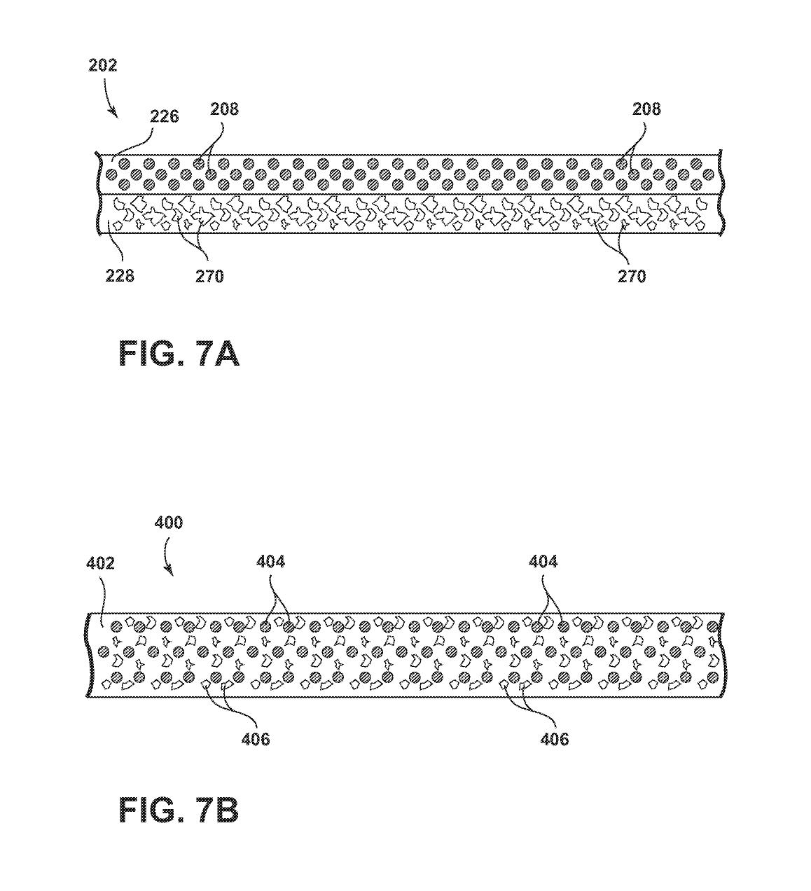

FIG. 7A is a schematic representation of a single layer of polymeric composite-induction tape 202 according to an embodiment of the invention for the purposes of discussion and is not meant to limit the embodiments of the invention in any way. The polymeric composite tape layer 226 can include reinforcement material 208 in the form of glass fibers for example, as discussed above. The induction film 228 includes induction current-susceptible particles 270, such as iron or other suitable metal particles, for example. Providing the reinforcement material 208 in a separate layer from the induction current-susceptible particles 270, rather than in a single layer with the induction current susceptible particles 270, can minimize the abrasion of the reinforcement material 208 that can occur from interaction of the reinforcement material 208 with the induction current-susceptible particles 270 and any other filler material present in the induction film 228. Embedding solid particulate material close to or on reinforcement material can result in premature failure of the material under tensile loading and impact the cyclic fatigue of the material.

For example, in the field of oil and gas pipe lines, the pipe components are typically exposed to high pressures and are often expected to have an operation life span of 20 to 50 years. Providing the reinforcement material 208 in a separate layer from the induction current-susceptible particles 270 can reduce undesired interactions between the reinforcement material 208 and the induction current-susceptible particles 270 that could decrease the operation life span of the polymeric composite-induction tape 202 and components formed using the tape 202. The separate induction film layers 228 and polymeric composite tape layers 226 can expand and contract and fuse independently, which can contribute to the stability and the integrity of the polymeric composite-induction tape 202 during the operation life span of the pipe.

In addition, providing the induction-current susceptible particles 270 within the polymer resin melt matrix used to form the polymeric composite tape layer 226 can interfere with the impregnation process of the polymer resin melt matrix with the reinforcement material 208, as the induction-current susceptible particles 270 can abrade the reinforcement material 208 as well as increase the viscosity of the polymer resin melt matrix, which can slow or inhibit the impregnation process.

Furthermore, providing separate induction film layers 228 and polymeric composite tape layers 226 provides for opportunities to tailor each layer to provide the final product with the desired properties. For example, the induction film layer 228 can be provided as a tough, highly elastic polymer layer with a high elongation to break that can increase the impact resistance and the cold weather performance of the polymeric composite-induction tape 202. The polymeric composite tape layer 226 can be made from a resin with a higher viscosity than that of the resin used to form the induction film layer 228 to provide the polymeric composite tape layer 226 with different characteristics than that of the induction film layer 228.

In addition, because it is the induction film layer 228 that is providing the heat to melt the adjacent polymeric composite tape layer 226 on an adjacent polymeric-composite induction tape 202, it is not necessary to heat the polymeric composite tape layer 226 such that the entire polymeric composite tape layer 226 melts. It is sufficient to only melt a portion of the polymeric composite tape layer 226 such that a suitable degree of bonding between the polymeric composite tape layer 226 and the adjacent induction film layer 228 occurs. Heating the polymeric composite tape layer 226 to a degree such that the entire polymeric composite tape layer 226 melts can contribute to cycle fatigue of the layer.

In contrast to the present embodiments of the invention, FIG. 7B illustrates a thermoplastic tape 400 that comprises a single resin matrix layer 402 impregnated with a reinforcement material 404 and induction current-susceptible material 406. Because the reinforcement material 404 and induction current-susceptible material 406 are provided in the same resin matrix 402, the resin matrix has to be simultaneously suitable for both materials. In addition, the presence of the induction current-susceptible material 406 in the same resin matrix layer 402 as the reinforcement material 404 can abrade the reinforcement material 404 during the impregnation process and also during subsequent expansion and contraction cycles during the bonding process and in use. Furthermore, the induction current-susceptible material 406 can interfere with the impregnation process of the resin matrix layer 402 and the reinforcement material 404, as the induction current-susceptible material 406 can increase the viscosity of the resin matrix layer 402, which can slow or inhibit the impregnation process. In addition, the viscosity of the resin matrix layer 402 will have to be sufficiently low to allow for impregnation of the reinforcement material 404, which can limit the impact resistance and elongation to break of the thermoplastic tape 400, as low viscosity resins typically do not provide high impact resistance or elongation to break performance. In addition, the use of a single resin matrix layer 402 instead of multiple layers does not provide the opportunity to select different layers having different properties to provide the final product with the desired combination of properties.

To the extent not already described, the different features and structures of the various embodiments may be used in combination with each other as desired. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly disclosed.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A composite article for fusing to a substrate comprising:
a polymeric composite layer having a first polymeric matrix comprising at least one polymeric resin; and
an induction layer joined to the polymeric composite layer, wherein the induction layer has an induction-current susceptible material that generates heat when exposed to a magnetic field; and
wherein the induction layer is separate from the polymeric composite layer.

2. The composite article of claim 1 wherein the first polymeric matrix includes a reinforcement material.

3. The composite article of claim 1 wherein the induction layer includes a carrier matrix with at least one polymeric resin.

4. The composite article of claim 3 wherein the first polymeric matrix and the carrier matrix comprise the same polymeric resin.

5. The composite article of claim 3 wherein the at least one polymeric resin of the first polymeric matrix comprises a polyethylene-based resin.

6. The composite article of claim 1 wherein the induction-current susceptible material is a metal particulate.

7. A method of forming a composite article for fusing to a substrate comprising:
providing a polymeric composite layer having a first polymeric matrix comprising at least one polymeric resin;
providing an induction layer having an induction-current susceptible material that generates heat when exposed to a magnetic field; and
joining the induction layer to the polymeric composite layer, wherein the induction layer is separate from the polymeric composite layer.

8. The method of claim 7 further comprising forming the polymeric composite layer by combining a reinforcement material with a polymer resin.

9. The method of claim 8 wherein the reinforcement material comprises glass fibers and the forming includes heating the glass fibers.

10. The method of claim 8 wherein the polymer resin is applied to the reinforcement material by way of an extruder.

11. The method of claim 10 wherein the reinforcement material includes heated glass fibers and the forming includes moving the heated glass fibers and the applied polymer resin through heated pins to form a fully wet-out polymeric fiber composite.

12. The method of claim 7 wherein the joining step comprises applying at least one of heat, pressure or a combination of heat and pressure to at least one of the polymeric composite layer or the induction layer.

13. The method of claim 7 wherein the joining step includes heating the polymeric composite layer and applying the heated polymeric composite layer to the induction layer to form a bond between the polymeric composite layer and the induction layer.

14. The method of claim 7 wherein the joining step is combined with providing the induction layer step by heating and extruding a polymeric resin and the induction-current susceptible material onto the polymeric composite layer.

15. A method of joining a first polymeric material to a second polymeric material comprising:
providing a polymeric composite-induction tape formed of a polymeric composite layer having a first polymeric matrix with at least one polymeric resin, and a separate induction layer joined to the polymeric composite layer, wherein the induction layer has an induction-current susceptible material;
placing at least one layer of the polymeric composite-induction tape between the first polymeric material and the second polymeric material with at least one of the polymeric composite layer or the induction layer in contact with the first polymeric material and the other of the polymeric composite layer or the induction layer in contact with the second polymeric material; and
performing an induction cycle to melt at least one of the polymeric composite layer or induction layer to fuse the at least one of the polymeric composite layer or induction layer to the adjacent first polymeric material and the second polymeric material.

16. The method of claim 15 wherein the first polymeric material is a pipe jacket and the second polymeric material is a pipe liner.

17. The method of claim 16 wherein the placing step includes wrapping the at least one layer of polymeric composite-induction tape around the pipe liner.

18. The method of claim 17 wherein more than one layer of polymeric composite-induction tape is wrapped around the pipe liner and the performing step is repeated for each layer polymeric composite-induction tape.

19. The method of claim 15 wherein the placing at least one layer of polymeric composite-induction tape and the performing an induction cycle are repeated at least once to join the first polymeric material to the second polymeric material by at least two layers of polymeric composite-induction tape.
